(19) United States
(12) Patent Application Publication
(10) Pub. No.: US 2006/0088290 A1
(43) Pub. Date: Apr. 27, 2006

(54) Controller device connected via IEEE 1394 serial bus to device having tuner function and digital recording device

(75) Inventor: Atsushi Takagi, Daito-shi (JP)

Correspondence Address: CROWELL & MORING LLP;INTELLECTUAL PROPERTY GROUP, P.O. BOX 14300, WASHINGTON, DC, 20044-4300, US

(73) Assignee: Funai Electric Co., Ltd., Daito-shi (JP)

(21) Appl. No.: 11/258,917

(22) Filed: Oct. 27, 2005

(30) Foreign Application Priority Data
Oct. 27, 2004 (JP) 2004-312125

(51) Int. Cl. H04N 5/76; H04N 5/781

(52) U.S. Cl. 386/83; 386/125

(57) ABSTRACT

A controller device such as a digital television receiver that is connected via an IEEE 1394 serial bus to a device having a tuner function and a digital recording device compares a keyword entered by a user with information about each program that is contained in program schedule information received by each device on the IEEE 1394 network that has a tuner circuit to determine whether there is a match, thereby searching for a program corresponding to the keyword among all programs receivable by any device on the network that has a tuner circuit. The controller device then performs timer recording for programs in a list of programs found as a result of the search.

### BACKGROUND OF THE INVENTION

1. Field of the Invention

The present invention relates to a controller device such as a digital television receiver or the like that can be connected via an IEEE 1394 serial bus to a device having a tuner function and a digital recording device such as a hard disk recorder or the like.

2. Description of the Related Art

It is known to connect a controller device such as a digital television receiver via an IEEE 1394 serial bus to a digital recording device such as a hard disk recorder for control of the digital recording device. For programming the conventional controller device to make the digital recording device record a series of television programs, a user needs to select each episode of the desired series from among programs contained in program schedule information for digital broadcasts that can be received by a tuner circuit provided in the controller device itself to request recording of the each episode. However, the above described programming method for timer recording of a series of programs has the following drawback. The method allows timer recording only for digital broadcast programs receivable by the tuner circuit provided in the controller device itself. Accordingly, in such a case where a series of programs desired to be recorded is a rerun and a given episode of the series is not broadcast due to a special program via digital television signals receivable by the tuner circuit provided in the controller device, recording of the given episode of the series may be missed.

### SUMMARY OF THE INVENTION

An object of the present invention is to provide a controller device that, even where an episode of a series of programs desired to be recorded is not broadcast due to some reason via digital television signals receivable by one of tuner circuits, can prevent missing of recording of the episode.

According to an aspect of the present invention, we provide a controller device connected via an IEEE 1394 serial bus to at least one device having a tuner function and to a digital recording device, multiple types of tuner circuits being provided in devices in an IEEE 1394 network including the controller device, the at least one device having the tuner function, and the digital recording device, the controller device comprising: selection means for selecting a program for timer recording from among all programs receivable by any of the multiple types of tuner circuits; scheduled date and time determining means for determining whether a date and time when a broadcast of the program selected via the selection means is scheduled to start has arrived; and timer recording performing means for, when it is determined by the scheduled date and time determining means that the date and time when the broadcast of the selected program is scheduled to start has arrived, performing a timer recording process by instructing a device with a tuner circuit that can receive the program selected via the selection means to send stream data on the selected program to the digital recording device and by instructing the digital recording device to record the stream data sent from the device with the tuner circuit.

The selection means includes: keyword entry means for entering a keyword associated with a user-desired program; and program search means for searching for a program corresponding to the keyword among all the programs receivable by any device on the IEEE 1394 network that has a tuner circuit by comparing the keyword entered via the keyword entry means with information about each program that is contained in program schedule information received by each device on the IEEE 1394 network that has a tuner circuit to determine whether there is a match.

The timer recording performing means performs the timer recording process for a program found as a result of the search performed via the program search means.

With the above configuration, a search is performed for a program corresponding to a keyword entered by a user among all programs receivable by any device on the IEEE 1394 network that has a tuner circuit, so that a timer recording process is performed for programs included in a list of programs found as a result of the search. Accordingly, even where an episode of a user-desired series of programs is not broadcast, due to some reason, via digital television signals receivable by one of tuner circuits on the IEEE 1394 network, the controller device can perform timer recording for the episode of the series in the case where the episode of the series is broadcast via digital television signals receivable by any other tuner circuit on the IEEE 1394 network. This can reduce the frequency of missing recording of an episode of a series.

Preferably, the selection means further includes: display means for displaying a list of programs found as a result of the search performed by the program search means; and timer recording requesting means for requesting timer recording of programs in the list displayed on the display means, wherein the timer recording performing means performs the timer recording process for the programs requested by a user via the timer recording requesting means. This allows the user to check the list displayed on the display means that shows the result of the search for programs corresponding to the keyword before requesting the timer recording. Thus, recording an undesired program can be prevented.

Preferably, the controller device further comprises storage means for storing a content of the program list displayed on the display means when the timer recording of the programs are requested via the timer recording requesting means, and the timer recording performing means performs the timer recording process for the programs in the program list based on the content of the program list stored in the storage means.

Preferably, keywords used for a program search via the program search means include a title of a user-desired series of programs and a name of a personality scheduled to appear on the series. Even where both an original and a remake of a series are broadcast in the same season, the personality's name included in the keywords allows a user to instruct the controller device to record only one of the original and the remake.

The controller device may have a tuner circuit.

The controller device may be a digital television receiver.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic perspective view showing a DTV according to one embodiment of the present invention that is connected to three STBs, a DTV, and an AVHDD;

FIG. 2 is an electrical block diagram showing the DTV and one of the STBs;

FIG. 3 is an electrical block diagram showing the AVHDD;

FIG. 4 is a flowchart showing a process performed by the DTV for timer recording of a series of programs on the AVHDD;

FIG. 5 shows a timer recording selection screen displayed on the monitor of the DTV, FIG. 6 shows a keyword entry screen displayed on the monitor of the DTV; and

FIG. 7 shows timer recording program listing screen displayed on the monitor of the DTV.

### DESCRIPTION OF THE PREFERRED EMBODIMENT

Referring now to the accompanying drawings, the preferred embodiment of the present invention is described. The present invention relates to a controller device such as a digital television receiver or the like that can be connected via an IEEE 1394 serial bus to a device having a tuner function and a digital recording device. In the embodiment described below, a controller device according to the present invention is a digital television receiver. It is to be noted that the following description of preferred embodiment of the present invention has been presented for purposes of illustration and description, and is not intended to be exhaustive or to limit the present invention to the precise form disclosed.

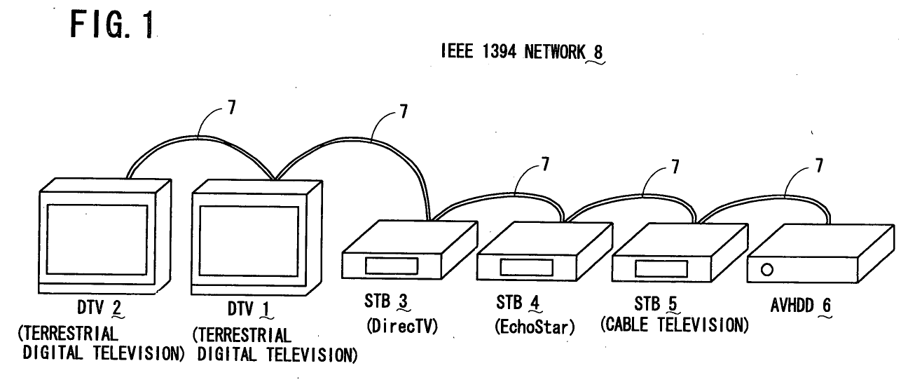

FIG. 1 schematically shows an external view of a digital television receiver 1 according to one embodiment of the present invention that is connected to three set-top boxes 3 to 5, another digital television receiver 2, and an audio/video hard disk drive (AVHDD) 6. Each of the digital television receivers (hereinafter referred to as “DTV”) 1 and 2 has an integrated tuner circuit capable of receiving terrestrial digital television broadcasts. Each of the DTVs 1 and 2 can serve as a controller device for the set-top boxes (hereinafter referred to as “STBs”) 3 to 5 and the AVHDD 6. The STBs 3, 4, and 5 have therein tuner circuits capable of receiving DirecTV, EchoStar, and cable television signals, respectively, so as to output a television signal on a user-selected channel among received television signals. The AVHDD 6 is a hard disk recorder of a type that is capable of recording or reproducing data in response only to a control command conforming to the IEEE 1394 standard. The DTV 1 and the DTV 2, the DTV 1 and the STB 3, the STB 3 and the STB 4, the STB 4 and the STB 5, and the STB 5 and the AVHDD 6 are connected by IEEE 1394 serial bus cables 7. More particularly, the DTVs 1 and 2, the STBs 3, 4, and 5, and the AVHDD 6 are included in an IEEE 1394 network 8. A user is allowed to select a desired program for timer recording from among all programs receivable by any of the devices on the IEEE 1394 network 8 that have the tuner circuits (i.e., the DTVs 1 and 2, and the STBs 3, 4, and 5).

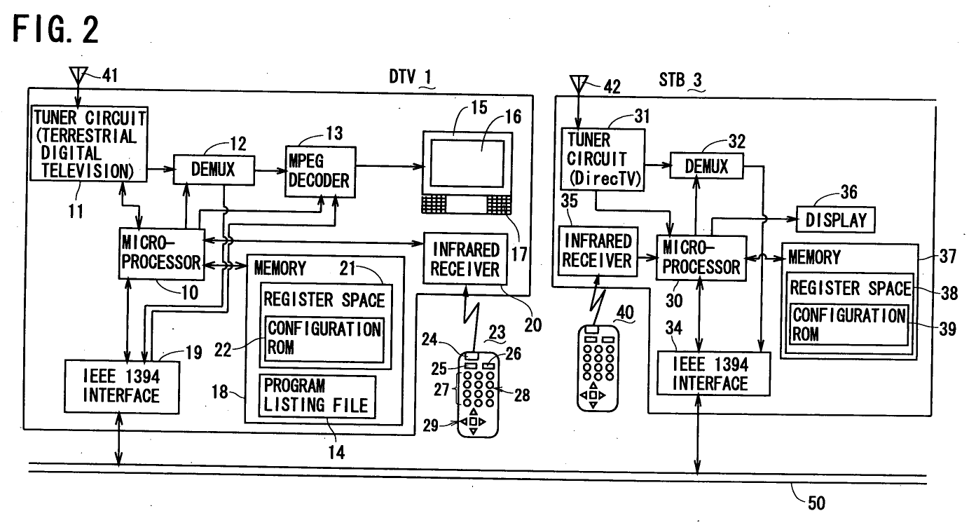

Referring now to FIG. 2, the electrical configuration of the DTV 1 and the STB 3 is described. The DTV 1 is connected to an antenna 41, and comprises a tuner circuit 11 for receiving terrestrial digital television broadcasts, a DEMUX 12 for extracting video and audio packets of a user-selected program from a transport stream received by the tuner circuit 11, an MPEG decoder 13 for decoding MPEG compressed video and audio packets received from the DEMUX 12 to reproduce video and audio signals, and a monitor 15. The monitor 15 includes a screen 16 (display means) for displaying a reproduced image and a loudspeaker 17 for outputting a reproduced sound. The DTV 1 further comprises a microprocessor 10 (scheduled date and time determining means, timer recording performing means, and program search means) for controlling each component in the DTV 1, a memory 18 (storage means) for storing various kinds of data, an IEEE 1394 interface (hereinafter referred to as “interface”) 19 for sending and receiving data between the DTV 1 and any other device connected to a bus 50, and an infrared receiver 20 for receiving an infrared signal transmitted from a remote control 23. The memory 18 stores data such as a register space 21 that contains various kinds of information concerning the node (DTV 1) itself and other nodes on the bus 50 and a program listing file 14 that contains data representing a list of programs found as a result of a keyword search described later, and stores various programs including a program for timer recording of a series of programs, which is described later. The register space 21 includes a configuration ROM 22 that stores e.g. information about the performance of the device (DTV 1) itself.

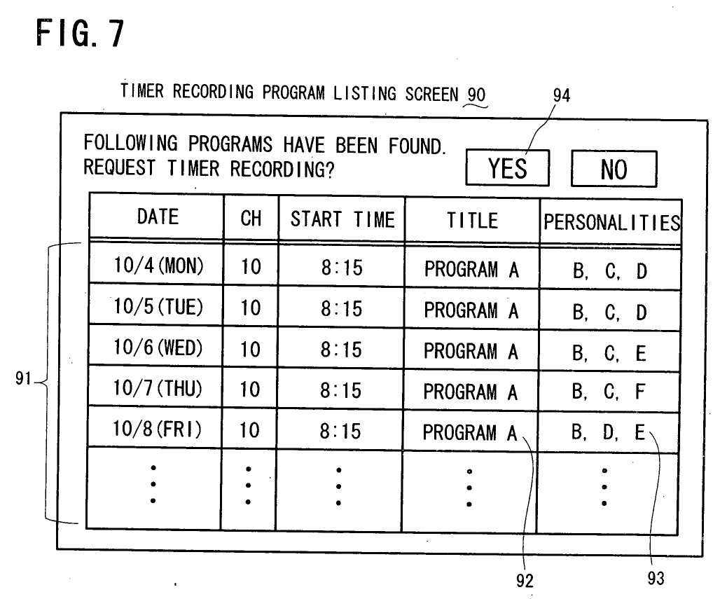

The remote control 23 (keyword entry means and timer recording requesting means) has an infrared transmitter 24 and a key portion 28, where arranged are various keys such as a power key 26, numeric keys 27, cursor keys 29, and a menu key 25 for causing various menus to be displayed. Claimed selection means comprises the remote control 23, a keyword entry screen 80 (see FIG. 6), a timer recording program listing screen 90 (see FIG. 7), and the microprocessor 10.

The STB 3 comprises a microprocessor 30 for controlling each component therein. The microprocessor 30 is connected to a tuner circuit 31, a DEMUX 32, an IEEE 1394 interface (hereinafter referred to simply as “interface”) 34, an infrared receiver 35, a display 36, and a memory 37.

The tuner circuit 31 is configured to receive DirecTV signals and extracts a television signal on a user-selected channel from television signals received via an antennal 42. The DEMUX 32 extracts video and audio packets of a user-selected program from a transport stream received by the tuner circuit 31. The interface 34 is an interface circuit for sending and receiving data between the STB 3 and any other device on the bus 50. The infrared receiver 35 receives an infrared command signal transmitted from a remote control 40 and converts the command signal into a standard digital signal for output to the microprocessor 30. The display 36 is used to display e.g. various messages. The memory 37 stores a register space 38 containing various kinds of information concerning the node (STB 3) itself and other nodes on the bus 50. The register space 38 includes a configuration ROM 39 that stores e.g. information about the performance of the device (STB 3) itself. The remote control 40 is configured similar to the remote control 23 of the DTV 1, and thus the configuration is not described repeatedly.

The STBs 4 and 5 shown in FIG. 1 have therein the tuner circuits configured to receive EchoStar and cable television signals, respectively. Except for the tuner circuits, the STBs 4 and 5 are configured basically similar to the STB 3 of which the configuration is shown in FIG. 2.

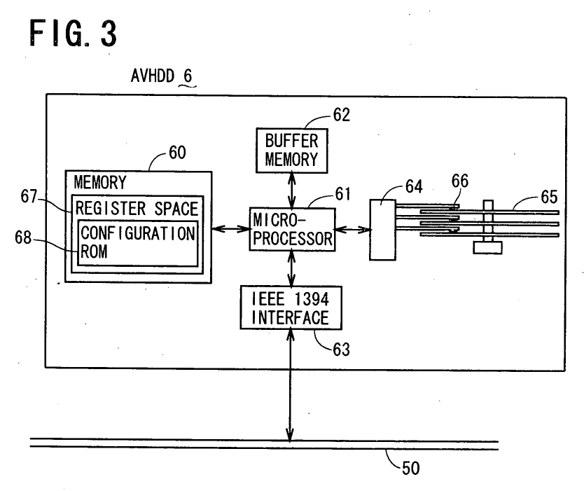

Referring now to FIG. 3, the configuration of the AVHDD 6 is described. The AVHDD 6 comprises a microprocessor 61 for controlling each component in the AVHDD 6, a memory 60 for storing a register space 67 and control programs for the microprocessor 61, and an IEEE 1394 interface (hereinafter referred to simply as “interface”) 63 for receiving a control command and data such as stream data from the DTV 1 via the bus 50. The register space 67 includes a configuration ROM 68 that stores e.g. information about the performance of the AVHDD 6 itself. The AVHDD 6 further comprises a plurality of hard disks 65 on which data is recorded, a plurality of magnetic heads 66 for recording and reading data on and from the hard disks 65, a head drive unit 64 for driving the magnetic heads 66, and a buffer memory 62 for temporarily storing data to be recorded or data read.

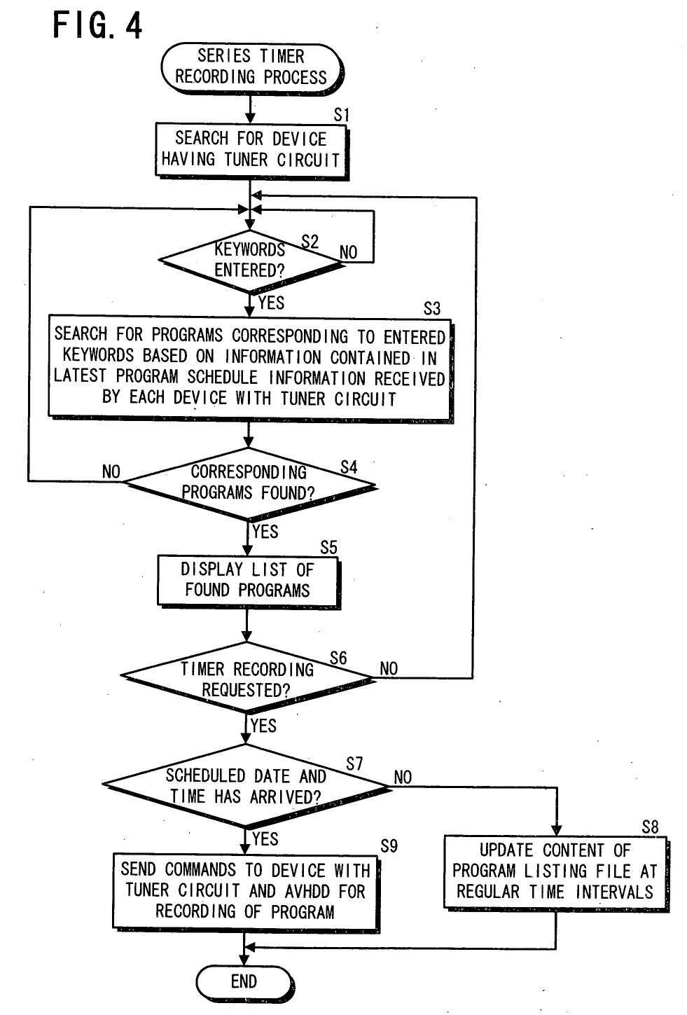

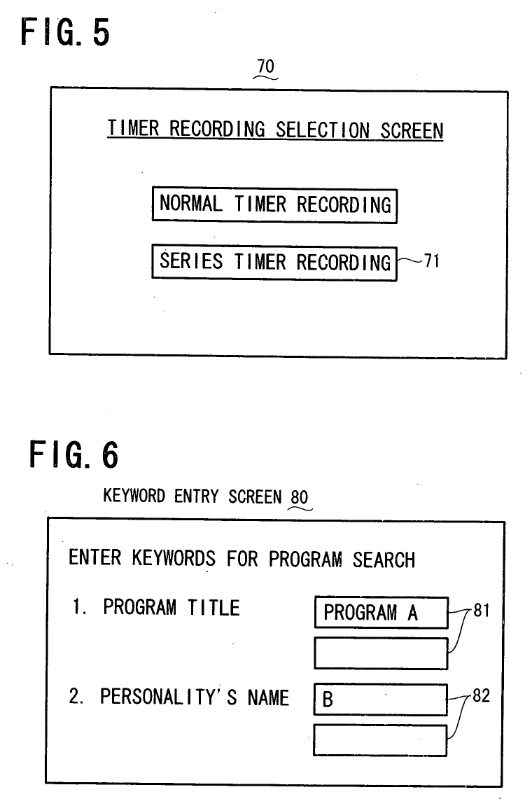

Referring now to the flowchart of FIG. 4 along with FIGS. 5 to 7, a process is described that is performed by the DTV 1 for timer recording of a series of programs on the AVHDD 6. This process starts when a user instructs the DTV 1 to display a timer recording selection screen 70 shown in FIG. 5 on the monitor screen 16 and selects a series timer recording button 71 in the screen 70 by using the remote control 23. In response to the selection, the microprocessor 10 of the DTV 1 displays a keyword entry screen 80 shown in FIG. 6 on the monitor screen 16 so as to prompt a user to enter a keyword. At the same time, the microprocessor 10 performs a search for a device having a tuner circuit among all the devices, including the DTV 1 itself, on the IEEE 1394 network 8 (S1), and acquires program schedule information from each device found as a result of the search to store part of the information in the memory 18. Subsequently, when the user enters a keyword of a program title of a desired series and a keyword of a name of a personality scheduled to appear on the series that are used for a search for a series of programs into a program title keyword field 81 and a personality's name keyword field 82, respectively, in the keyword entry screen 80 by using the remote control 23 (YES at S2), the microprocessor 10 of the DTV 1 compares the program title and personality's name keywords entered by the user with program title and personality's name information for each program that is contained in the program schedule information stored in the memory 18 so as to determine whether there is a match. Thereby, the microprocessor 10 performs the search for programs corresponding to the keywords among all programs receivable by any of the devices with the tuner circuits, which include the DTV 1 itself, on the IEEE 1394 network 8 (S3).

If programs corresponding to the keywords are found as a result of the above search (YES at S4), the microprocessor 10 of the DTV 1 displays on the monitor screen 16 a timer recording program listing screen 90 that presents a list 91 containing information about each of the found programs such as the date scheduled for the broadcast, the program title 92, the personality's names 93, and so on as shown in FIG. 7 (S5), and prompts the user to confirm the programs shown in the list 91 for timer recording. If the user requests the timer recording by selecting a “YES” button 94 on the timer recording program listing screen 90 via the remote control 23 (YES at S6), the microprocessor 10 of the DTV 1 stores the content of the list 91 as a program listing file 14 in the memory 18.

Subsequently, the microprocessor 10 of the DTV 1 determines whether or not the date and time when the broadcast of each of the programs to be recorded is scheduled to start has arrived based on the date and start time for each of the programs that is stored in the program listing file 14 and on the current time acquired from a timer not shown (S7). Until the scheduled date and time arrives (NO at S7), the microprocessor 10 updates the content of the program listing file 14 with the latest information at regular time intervals (S8) so as to prevent needless recording for a program of which the broadcast is canceled. When the scheduled date and time has arrived (YES at S7), the microprocessor 10 of the DTV 1 instructs a device with a tuner circuit (the DTV 1 or 2, or the STB 3, 4, or 5) that can receive the relevant program to send stream data of the program to the AVHDD 6, and sends a command to the AVHDD 6 to cause the AVHDD 6 to record the stream data sent from the device with the tuner circuit, thereby performing a timer recording process (S9).

The process at the step S9 is described in more detail. When the scheduled date and time has arrived, the microprocessor 10 of the DTV 1 turns on the AVHDD 6 and the device with the tuner circuit that can receive the relevant program, and establishes a point-to-point connection between the AVHDD 6 and the device with the tuner circuit. The microprocessor 10 then sends a command to the device with the tuner circuit that can receive the relevant program for switching to a channel on which the relevant program is broadcast. Subsequently, the microprocessor 10 of the DTV 1 sends a command to the AVHDD 6 to start recording stream data sent from the device with the tuner circuit. When the program ends, the microprocessor 10 of the DTV 1 sends a command for stopping the recording to the AVHDD 6, and then releases the point-to-point connection and turns off the AVHDD 6 and the device with the tuner circuit.

As described above, according to the DTV 1 of this embodiment, the microprocessor 10 performs a search for a program corresponding to a user-entered keyword among all programs receivable by any of the devices with the tuner circuits on the IEEE 1394 network 8 that include the DTV 1 itself, and performs the timer recording process for programs in a list (the list 91 shown within the timer recording program listing screen 90) of programs found as a result of the search. Accordingly, for example, even where an episode of a series of programs a user wishes to record is not broadcast due to some reason via terrestrial digital television signals receivable by the tuner circuit 11 provided in the DTV 1, timer recording for the episode of the series can be performed in the case where the episode of the series is broadcast via digital television signals (DirecTV, EchoStar, or cable television signals) receivable by any other tuner circuit on the IEEE 1394 network 8. This can reduce the frequency of missing recording of an episode of a series of programs.

Further, the microprocessor 10 of the DTV 1 compares user-entered keywords such as a program title and a personality's name with information about each program such as the program title and personality's names that is contained in program schedule information received from each of the devices with the tuner circuits on the IEEE 1394 network 8 and program schedule information received by the tuner circuit 11 of the DTV 1 itself to determine whether there is a match. Thereby, the microprocessor 10 performs the search for programs corresponding to the keywords among all programs receivable by any of the devices with the tuner circuits, including the DTV 1 itself, on the IEEE 1394 network 8. Accordingly, even where both an original and a remake of a series of programs are broadcast in the same season, only one of the original and the remake can be requested for timer recording.

Moreover, the DTV 1 according to this embodiment allows a user to check the list 91 displayed on the screen 16 of the monitor 15 that shows the result of a search for programs corresponding to a keyword entered by the user before requesting timer recording for the programs. This can prevent recording of an undesired program.

The present invention has been described above using a presently preferred embodiment, but those skilled in the art will appreciate that various modifications are possible. Accordingly, all such modifications are intended to be included within the spirit and scope of the present invention. For example, the present invention is applied to the DTV in the above described embodiment, but it is also applicable to a STB or other controller device. Further, the above described embodiment uses the AVHDD as the digital recording device by way of example, but a data-video home system (D-VHS) digital video tape recorder (VTR) or other digital recording device can be used instead of the AVHDD.

This application is based on Japanese patent application 2004-312125 filed Oct. 27, 2004, the contents of which are hereby incorporated by reference.

What is claimed is:

1. A controller device connected via an IEEE 1394 serial bus to at least one device having a tuner function and to a digital recording device, multiple types of tuner circuits being provided in devices in an IEEE 1394 network including the controller device, the at least one device having the tuner function, and the digital recording device,
the controller device comprising:
selection means for selecting a program for timer recording from among all programs receivable by any of the multiple types of tuner circuits;
scheduled date and time determining means for determining whether a date and time when a broadcast of the program selected via the selection means is scheduled to start has arrived; and
timer recording performing means for, when it is determined by the scheduled date and time determining means that the date and time when the broadcast of the selected program is scheduled to start has arrived, performing a timer recording process by instructing a device with a tuner circuit that can receive the program selected via the selection means to send stream data on the selected program to the digital recording device and by instructing the digital recording device to record the stream data sent from the device with the tuner circuit,
wherein the selection means includes:
keyword entry means for entering a keyword associated with a user-desired program; and
program search means for searching for a program corresponding to the keyword among all the programs receivable by any device on the IEEE 1394 network that has a tuner circuit by comparing the keyword entered via the keyword entry means with information about each program that is contained in program schedule information received by each device on the IEEE 1394 network that has a tuner circuit to determine whether there is a match,
wherein the timer recording performing means performs the timer recording process for a program found as a result of the search performed via the program search means.

2. The controller device according to claim 1, wherein the selection means further includes:
display means for displaying a list of programs found as a result of the search performed by the program search means; and
timer recording requesting means for requesting timer recording of programs in the list displayed on the display means,
wherein the timer recording performing means performs the timer recording process for the programs requested by a user via the timer recording requesting means.

3. The controller device according to claim 2, further comprising storage means for storing a content of the program list displayed on the display means when the timer recording of the programs are requested via the timer recording requesting means,
wherein the timer recording performing means performs the timer recording process for the programs in the program list based on the content of the program list stored in the storage means.

4. The controller device according to claim 3,
wherein keywords used for a program search via the program search means include a title of a user-desired series of programs and a name of a personality scheduled to appear on the series.

5. The controller device according to claim 4, wherein the controller device has a tuner circuit.

6. The controller device according to claim 5, wherein the controller device is a digital television receiver.

7. The controller device according to claim 3, wherein the controller device has a tuner circuit.

8. The controller device according to claim 2, wherein the controller device has a tuner circuit.

9. The controller device according to claim 2,
wherein keywords used for a program search via the program search means include a title of a user-desired series of programs and a name of a personality scheduled to appear on the series.

10. The controller device according to claim 1,
wherein keywords used for a program search via the program search means include a title of a user-desired series of programs and a name of a personality scheduled to appear on the series.

11. The controller device according to claim 1, wherein the controller device has a tuner circuit.

12. The controller device according to claim 1, wherein the controller device is a digital television receiver.
